(19) United States
(12) Patent Application Publication
(10) Pub. No.: US 2018/0003348 A1
(43) Pub. Date: Jan. 4, 2018

(54) LED BULB STRUCTURE

(71) Applicant: WEN-SHIN PAN, TAIPEI CITY (TW)

(72) Inventor: WEN-SHIN PAN, TAIPEI CITY (TW)

(21) Appl. No.: 15/541,059

(22) PCT Filed: Dec. 28, 2015
(86) PCT No.: PCT/CN2015/099173

§ 371 Date: Jun. 30, 2017

(30) Foreign Application Priority Data
Dec. 31, 2014 (CN) 201410851941.6

(51) Int. Cl. F21K 9/235; F21V 23/00; F21V 7/22; F21K 9/237; F21K 9/68; F21V 29/508; F21K 9/232; F21K 9/238; F21K 9/61; F21V 23/04; F21V 29/74; F21Y 2115/10; F21Y 2105/12

(52) U.S. Cl. CPC F21K 9/235; F21V 23/0435; F21V 23/006; F21V 7/22; F21K 9/237; F21K 9/68; F21V 29/745; F21V 29/508; F21K 9/232; F21K 9/238; F21K 9/61; F21Y 2105/12; F21Y 2115/10

(57) ABSTRACT

An LED bulb structure includes a heat dissipation base, a power connector, a light-emitting module, an insulation cover, and a light-guiding cover. The power connector is disposed on a bottom side of the heat dissipation base. The light-emitting module includes a circuit substrate disposed on a top side of the heat dissipation base and a plurality of LED chips electrically connected to the circuit substrate. The LED chips are surroundingly disposed on the circuit substrate and adjacent to an outer perimeter surface of the circuit substrate. The insulation cover is disposed on the circuit substrate, and the insulation cover has a surrounding main portion and a convex portion disposed on a top side of the surrounding main portion. The light-guiding cover is disposed on the insulation cover. The light-guiding cover has a through opening formed on a top side thereof for exposing the convex portion.

### BACKGROUND OF THE INVENTION

### 1. Field of the Invention

The instant disclosure relates to an LED bulb structure, and more particularly to an LED bulb structure including a plurality of LED chips surroundingly disposed on a circuit substrate and adjacent to an outer perimeter surface of the circuit substrate.

### 2. Description of Related Art

The invention of the bulb greatly changed the style of building construction and the lifestyle of human beings, allowing people to work during the night. Traditional lighting devices such as bulbs that adopt incandescent bulbs, fluorescent bulbs, or power-saving bulbs have been generally well-developed and used intensively for indoor illumination. Moreover, compared to the newly developed light-emitting-diode (LED) bulbs, these traditional bulbs have the disadvantages of quick attenuation, high power consumption, high heat generation, short service life, high fragility, and being not recyclable. Thus, various high-powered LED bulbs are created to replace the traditional lighting devices.

### SUMMARY OF THE INVENTION

One aspect of the instant disclosure relates to an LED bulb structure including a plurality of LED chips surroundingly disposed on a circuit substrate and adjacent to an outer perimeter surface of the circuit substrate, so as to reduce heat-dissipating path of the LED chips and increase heat-dissipating efficiency of the LED chips.

One of the embodiments of the instant disclosure provides an LED bulb structure, comprising a heat dissipation base, a power connector, a light-emitting module, a driving circuit, an insulation cover, and a light-guiding cover. The heat dissipation base has a plurality of surrounding heat-dissipating fins surroundingly disposed on an outer perimeter surface thereof. The power connector is disposed on a bottom side of the heat dissipation base. The light-emitting module includes a circuit substrate disposed on a top side of the heat dissipation base and a plurality of LED chips electrically connected to the circuit substrate, and the LED chips are surroundingly disposed on a top surface of the circuit substrate and adjacent to an outer perimeter surface of the circuit substrate. The driving circuit is electrically connected between the power connector and the light-emitting module. The insulation cover is disposed on the circuit substrate. The insulation cover has a surrounding main portion, a convex portion disposed on a top side of the surrounding main portion, and a surrounding extending portion outwardly and surroundingly extended from a bottom side of the surrounding mina body and disposed on the circuit substrate, and the surrounding extending portion has a plurality of through holes for respectively receiving the LED chips. The light-guiding cover is disposed on the surrounding extending portion of the insulation cover to cover the surrounding main portion of the insulation cover. The light-guiding cover has a through opening formed on a top side thereof for exposing the convex portion, the light-guiding cover has a plurality of light input curved surfaces inwardly concaved therefrom and respectively facing the LED chips, the light-guiding cover has a light-reflecting curved surface and a light output curved surface respectively formed on an inner surface and an outer surface thereof, and a thickness of the light-guiding cover is decreased gradually from bottom to top. A first receiving space is formed above the circuit substrate and surrounded by the insulation cover, a second receiving space is formed under the circuit substrate and is surrounded by the heat dissipation base, and the driving circuit is placed inside one of the first receiving space and the second receiving space.

More particularly, the heat dissipation base has a plurality of top heat-dissipating fins disposed on the top side thereof for surrounding the light-emitting module, and the top heat-dissipating fins directly contact the circuit substrate of the light-emitting module.

More particularly, the light-guiding cover includes a light-guiding body, a plurality of reflective microparticles disposed inside the light-guiding body, and a plurality of carrier substances disposed inside the light-guiding body to carry the reflective microparticles to be uniformly diffused inside the light-guiding body, wherein the refractive of the light-guiding body is different from the index refractive index of the reflective microparticle, the viscosity of the carrier substance is smaller than the viscosity of the light-guiding body, and the flowability of the reflective microparticles inside the light-guiding body is increased through the carrier substances, wherein the light-guiding cover includes a plurality of light-guiding microstructures disposed on the light-reflecting curved surface and a light-reflecting layer disposed on the light-reflecting curved surface to cover the light-guiding microstructures, and the index refractive index of the light-guiding microstructure is different from the index refractive index of the light-reflecting layer, wherein the light pattern of an illuminating light source generated by the LED bulb structure is adjusted according to the number of the light-guiding microstructures.

More particularly, the convex portion of the insulation cover has a curved surface formed on a top side thereof, the curved surface of the insulation cover and the light output curved surface of the light-guiding cover are formed on a same sphere track, and a surrounding gap is formed between the convex portion of the insulation cover and the light-guiding cover and inside the through opening, wherein the convex portion has a receiver receiving space formed therein and communicated with the first receiving space, and a wireless signal receiver or a wireless signal transmitter is received inside the receiver receiving space of the convex portion.

Another one of the embodiments of the instant disclosure provides an LED bulb structure, comprising a heat dissipation base, a power connector, a light-emitting module, an insulation cover, and a light-guiding cover. The power connector is disposed on a bottom side of the heat dissipation base. The light-emitting module includes a circuit substrate disposed on a top side of the heat dissipation base and a plurality of LED chips electrically connected to the circuit substrate, and the LED chips are surroundingly disposed on a top surface of the circuit substrate and adjacent to an outer perimeter surface of the circuit substrate. The insulation cover is disposed on the circuit substrate, and the insulation cover has a surrounding main portion, a convex portion disposed on a top side of the surrounding main portion, and a surrounding extending portion outwardly and surroundingly extended from a bottom side of the surrounding mina body and disposed on the circuit substrate. The light-guiding cover is disposed on the surrounding extending portion of the insulation cover to cover the surrounding main portion of the insulation cover. The light-guiding cover has a through opening formed on a top side thereof for exposing the convex portion, the light-guiding cover has a light input curved surface, a light-reflecting curved surface, and a light output curved surface respectively formed on a bottom side, an inner surface, and an outer surface thereof, and a thickness of the light-guiding cover is decreased gradually from bottom to top.

Yet another one of the embodiments of the instant disclosure provides an LED bulb structure, comprising a heat dissipation base, a power connector, a light-emitting module, a driving circuit, an insulation cover, and a light-guiding cover. The heat dissipation base has a plurality of surrounding heat-dissipating fins surroundingly disposed on an outer perimeter surface thereof. The power connector is disposed on a bottom side of the heat dissipation base. The light-emitting module includes a circuit substrate disposed on a top side of the heat dissipation base and a plurality of LED chips electrically connected to the circuit substrate, and the LED chips are surroundingly disposed on a top surface of the circuit substrate and adjacent to an outer perimeter surface of the circuit substrate. The driving circuit is electrically connected between the power connector and the light-emitting module. The insulation cover is disposed on the circuit substrate. The light-guiding cover is covering the insulation cover. The light-guiding cover has a light input curved surface, a light-reflecting curved surface, and a light output curved surface respectively formed on a bottom side, an inner surface, and an outer surface thereof, and a thickness of the light-guiding cover is decreased gradually from bottom to top. A first receiving space is formed above the circuit substrate and surrounded by the insulation cover, a second receiving space is formed under the circuit substrate and is surrounded by the heat dissipation base, and the driving circuit is placed inside one of the first receiving space and the second receiving space.

Therefore, because the LED chips are surroundingly disposed on the top surface of the circuit substrate and adjacent to the outer perimeter surface of the circuit substrate, the heat-dissipating path of the LED chips is reduced and the heat-dissipating efficiency of the LED chips is increased.

To further understand the techniques, means and effects of the instant disclosure applied for achieving the prescribed objectives, the following detailed descriptions and appended drawings are hereby referred to, such that, and through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

The accompanying drawings are included to provide a further understanding of the instant disclosure, and are incorporated in and constitute a part of this specification. The drawings illustrate exemplary embodiments of the instant disclosure and, together with the description, serve to explain the principles of the instant disclosure.

FIG. 1 shows a perspective, exploded, schematic view of the LED bulb structure according to one of embodiments of the instant disclosure;

FIG. 2 shows another perspective, exploded, schematic view of the LED bulb structure according to one of embodiments of the instant disclosure;

FIG. 3 shows a perspective, assembled, schematic view of the LED bulb structure according to one of embodiments of the instant disclosure;

FIG. 4 shows a cross-sectional view taken along the section line A-A of FIG. 3;

FIG. 5 shows an enlarged view taken on part B of FIG. 4;

FIG. 6 shows a function block of the connection relationship among the power connector, the light-emitting module, and the driving circuit according to one of embodiments of the instant disclosure;

FIG. 7 shows a cross-sectional, schematic view of the LED bulb structure according to another one of embodiments of the instant disclosure; and

FIG. 8 shows a cross-sectional, schematic view of the LED bulb structure according to yet another one of embodiments of the instant disclosure.

### DETAILED DESCRIPTION OF THE PREFERRED EMBODIMENTS

The embodiments of an LED bulb structure of the instant disclosure are described. Other advantages and objectives of the instant disclosure can be easily understood by one skilled in the art from the disclosure. The instant disclosure can be applied in different embodiments. Various modifications and variations can be made to various details in the description for different applications without departing from the scope of the instant disclosure. The drawings of the instant disclosure are provided only for simple illustrations, but are not drawn to scale and do not reflect the actual relative dimensions. The following embodiments are provided to describe in detail the concept of the instant disclosure, and are not intended to limit the scope thereof in any way.

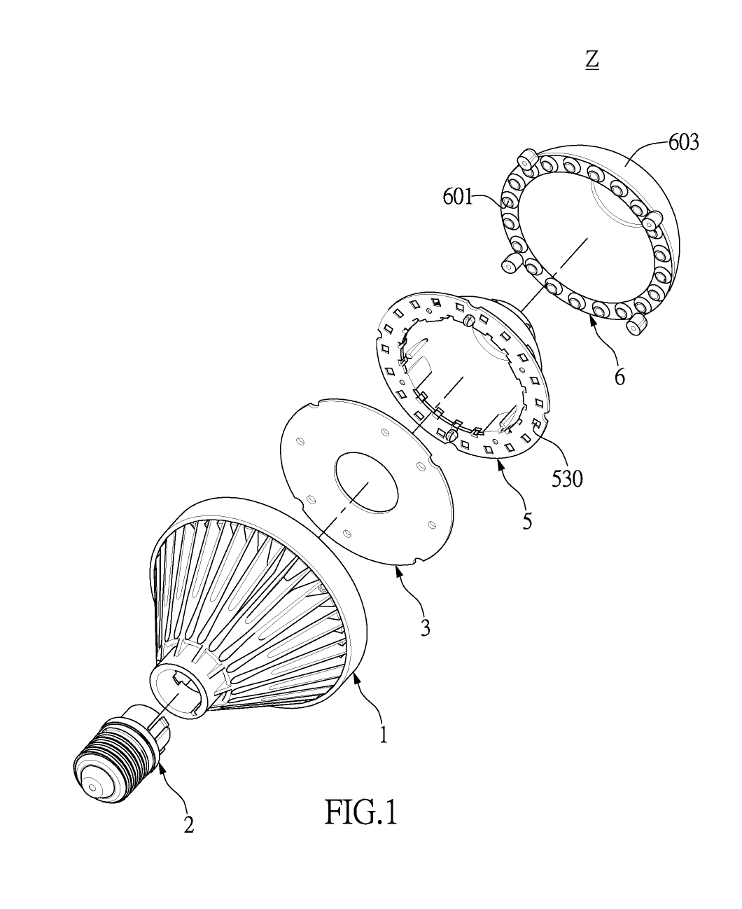

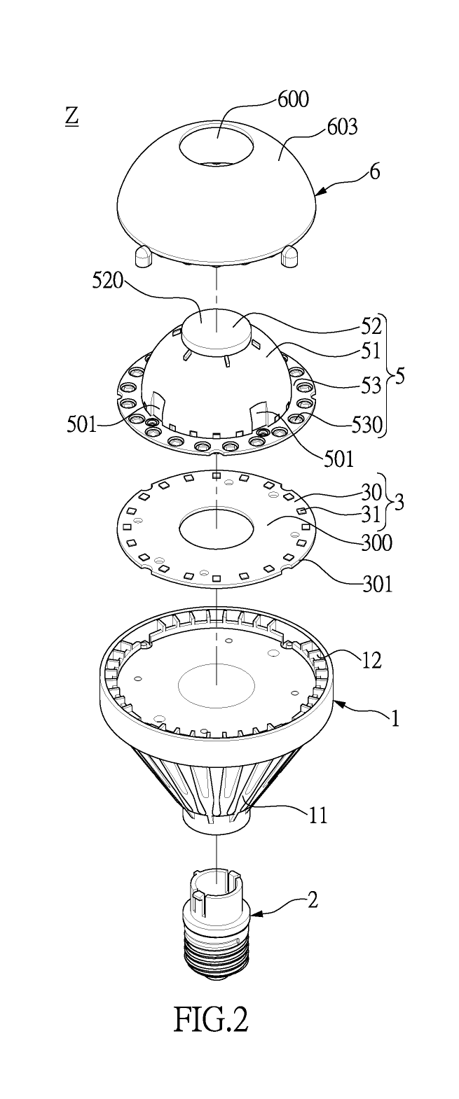

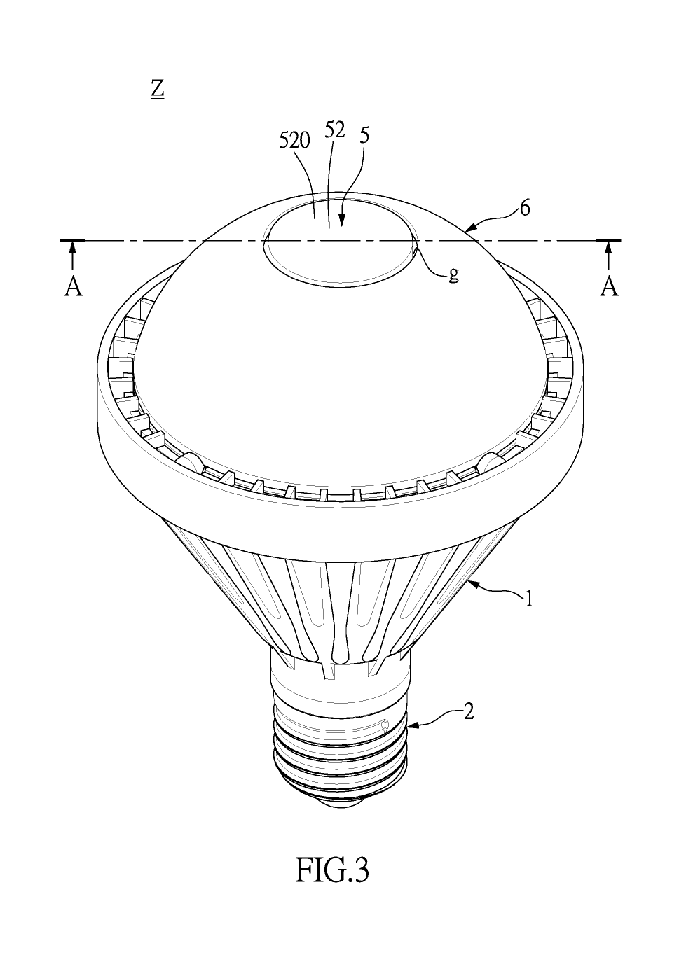

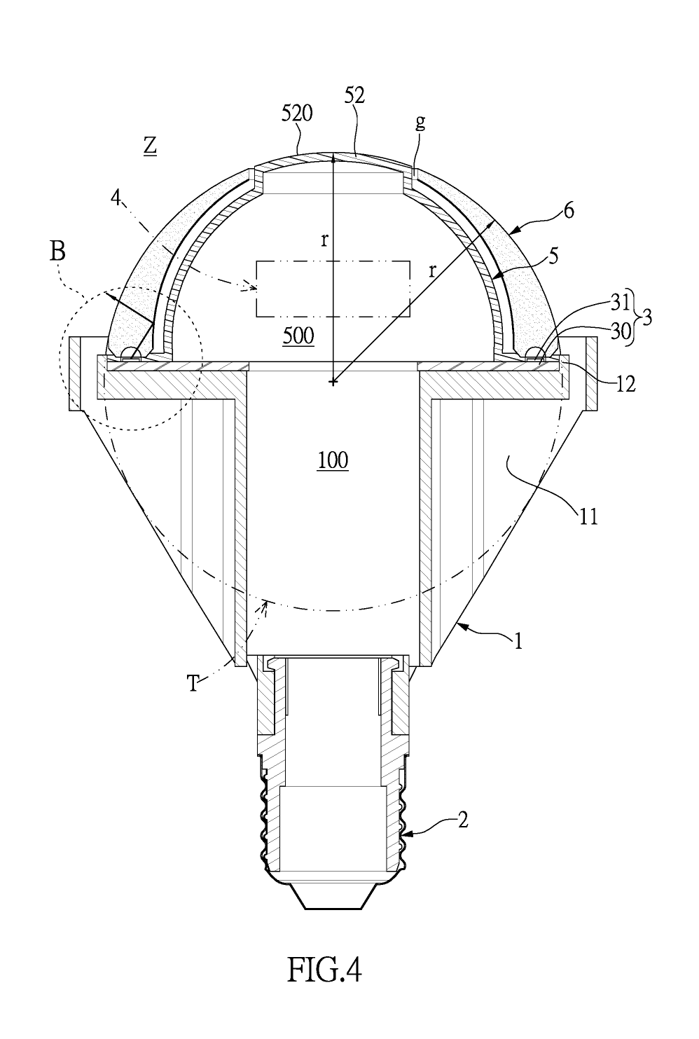

Referring to FIG. 1 to FIG. 4, FIG. 1 shows a perspective, exploded, schematic view of the LED bulb structure according to one of embodiments of the instant disclosure, FIG. 2 shows another perspective, exploded, schematic view of the LED bulb structure according to one of embodiments of the instant disclosure, FIG. 3 shows a perspective, assembled, schematic view of the LED bulb structure according to one of embodiments of the instant disclosure, and FIG. 4 shows a cross-sectional view taken along the section line A-A of FIG. 3. The instant disclosure provides an LED bulb structure Z, comprising: a heat dissipation base 1, a power connector 2, a light-emitting module 3, a driving circuit 4, an insulation cover 5, and a light-guiding cover 6.

First, referring to FIG. 2, FIG. 3, and FIG. 4, the heat dissipation base 1 has a plurality of surrounding heat-dissipating fins 11 surroundingly disposed on an outer perimeter surface (such as a surrounding peripheral surface) thereof, and the heat dissipation base 1 has a plurality of top heat-dissipating fins 12 disposed on the top side thereof for surrounding the light-emitting module 3. For example, the surrounding heat-dissipating fins 11 and the top heat-dissipating fins 12 may be made of any metal material. In addition, the surrounding heat-dissipating fins 11 may be connected to the top heat-dissipating fins 12, respectively. Alternatively, the surrounding heat-dissipating fins 11 and the top heat-dissipating fins 12 may be separated from each other, respectively.

Moreover, referring to FIG. 2, FIG. 3, and FIG. 4, the power connector 2 is disposed on a bottom side of the heat dissipation base 1. For example, the power connector 2 includes an insulation retaining body (not labeled) retained on the bottom side of the heat dissipation base 1 and separated from the heat dissipation base 1, a conductive retaining body (not labeled) shown as a screw structure connected to the insulation retaining body, and a conductive base (not labeled) disposed under the conductive retaining body and separated from the conductive retaining body. Therefore, the LED bulb structure Z can be positioned on and electrically connected to a power socket (not shown) through the power connector 2.

Furthermore, referring to FIG. 2, FIG. 3, and FIG. 4, the light-emitting module 3 includes a circuit substrate 30 disposed on a top side of the heat dissipation base 1 and a plurality of LED chips 31 or laser LED chips electrically connected to the circuit substrate 30. More particularly, the LED chips 31 are surroundingly disposed on a top surface 300 of the circuit substrate 30 and adjacent to an outer perimeter surface 301 of the circuit substrate 30. In addition, the top heat-dissipating fins 12 directly contact the circuit substrate 30 of the light-emitting module 3, so that the heat-dissipating efficiency of the circuit substrate 30 is increased. Please note, each LED chip 31 can correspond to a surrounding heat-dissipating fin 11 or a top heat-dissipating fin 12, for example, when the LED chip 31 is placed right above a corresponding surrounding heat-dissipating fin 11, the distance between the LED chip 31 and the corresponding surrounding heat-dissipating fin 11 can be minimized, so that the heat-dissipating efficiency of the LED chip 31 is increased.

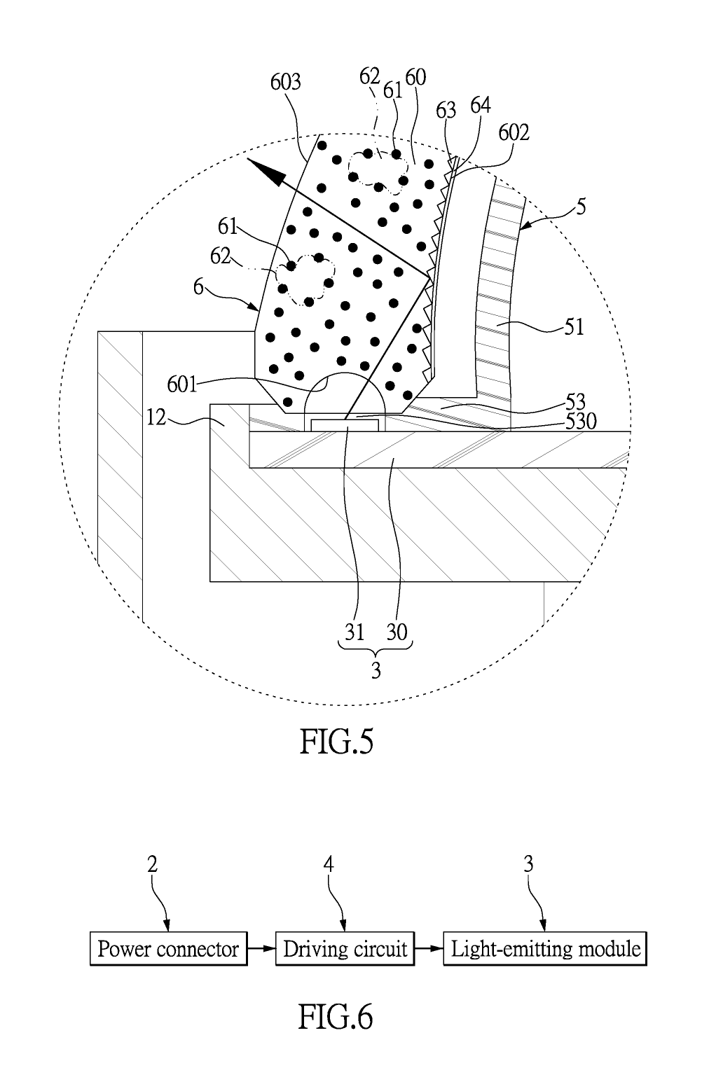

In addition, referring to FIG. 4 and FIG. 6, the driving circuit 4 is electrically connected between the power connector 2 and the light-emitting module 3. More particularly, a first receiving space 500 is formed above the circuit substrate 30 and surrounded by the insulation cover 5, a second receiving space 100 is formed under the circuit substrate 30 and is surrounded by the heat dissipation base 1, and the driving circuit 4 is placed inside one of the first receiving space 500 and the second receiving space 100. For example, as shown in FIG. 4, the driving circuit 4 is placed inside the first receiving space 500 of the insulation cover 5, so that an occupied space inside the heat dissipation base 1 can be reduced so as to decrease the size of the heat dissipation base 1 of the LED bulb structure Z.

Moreover, referring to FIG. 2, FIG. 4, and FIG. 5, the insulation cover 5 is disposed on the circuit substrate 30. The insulation cover 5 has a surrounding main portion 51, a convex portion 52 disposed on a top side of the surrounding main portion 51, and a surrounding extending portion 53 outwardly and surroundingly extended from a bottom side of the surrounding mina body 51 and disposed on the circuit substrate 30, and the surrounding extending portion 53 has a plurality of through holes 530 for respectively receiving the LED chips 31. Please, the insulation cover 5 has a plurality of vent openings 501 selectively disposed on the surrounding mina body 51 and the surrounding extending portion 53, but that is merely an example and is not meant to limit the instant disclosure.

Furthermore, referring to FIG. 1, FIG. 2, and FIG. 5, the light-guiding cover 6 is disposed on the surrounding extending portion 53 of the insulation cover 5 to cover the surrounding main portion 51 of the insulation cover 5. The light-guiding cover 6 has a through opening 600 formed on a top side thereof for exposing the convex portion 52, the light-guiding cover 6 has a plurality of light input curved surfaces 601 inwardly concaved therefrom and respectively facing the LED chips 31, and the light-guiding cover 6 has a light-reflecting curved surface 602 and a light output curved surface 603 respectively formed on an inner surface and an outer surface thereof. In addition, a thickness of the light-guiding cover 6 is decreased gradually from bottom to top, so that input light beams generated by the LED chips 31 pass through the light input curved surfaces 601 and are uniformly guided inside the light-guiding cover 6 due to the progressive thickness of the light-guiding cover 6.

More particularly, referring to FIG. 4 and FIG. 5, the light-guiding cover 6 includes a light-guiding body 60, a plurality of reflective microparticles 61 disposed inside the light-guiding body 60, and a plurality of carrier substances 62 disposed inside the light-guiding body 60 to carry the reflective microparticles 61 to be uniformly diffused inside the light-guiding body 60. The refractive of the light-guiding body 60 is different from the index refractive index of the reflective microparticle 61, the viscosity of the carrier substance 62 is smaller than the viscosity of the light-guiding body 60, and the flowability of the reflective microparticles 61 inside the light-guiding body 60 is increased through the carrier substances 62. Please note, the light pattern of an illuminating light source generated by the LED bulb structure Z can be adjusted or changeable according to the number of the light-guiding microstructures 61. Thus, the instant disclosure can adjust or change the number of the light-guiding microstructures 61 so as to obtain different light pattern of the illuminating light source generated by the LED bulb structure Z. In addition, the light-guiding cover 6 further includes a plurality of light-guiding microstructures 63 disposed on the light-reflecting curved surface 602 and a light-reflecting layer 64 disposed on the light-reflecting curved surface 602 to cover the light-guiding microstructures 63, and the index refractive index of the light-guiding microstructure 63 is different from the index refractive index of the light-reflecting layer 64.

More particularly, when the light-guiding microstructures 61 and the carrier substances 62 are mixed inside the light-guiding body 60, the carrier substances 62 can be used to carry the light-guiding microstructures 61 for increasing the flowability of the light-guiding microstructures 61 inside the light-guiding body 60. For example, the light-guiding body 60 may be made of any light-transmitting plastic material such as polymethylmethacrylate (PMMA), and the carrier substances 62 may be made of any light-transmitting organic or inorganic material such as a salad oil or a soybean oil. However, that is merely an example and is not meant to limit the instant disclosure.

Moreover, referring to FIG. 2, FIG. 3, and FIG. 4, the convex portion 52 of the insulation cover 5 has a curved surface 520 formed on a top side thereof, the curved surface 520 of the insulation cover 52 and the light output curved surface 603 of the light-guiding cover 6 are formed on a same sphere track T. In other words, the radius r of the sphere track T is the same as the distance from the center of the sphere track T to the curved surface 520 or the light output curved surface 603. In addition, a surrounding gap g is formed between the convex portion 52 of the insulation cover 5 and the light-guiding cover 6 and inside the through opening 600.

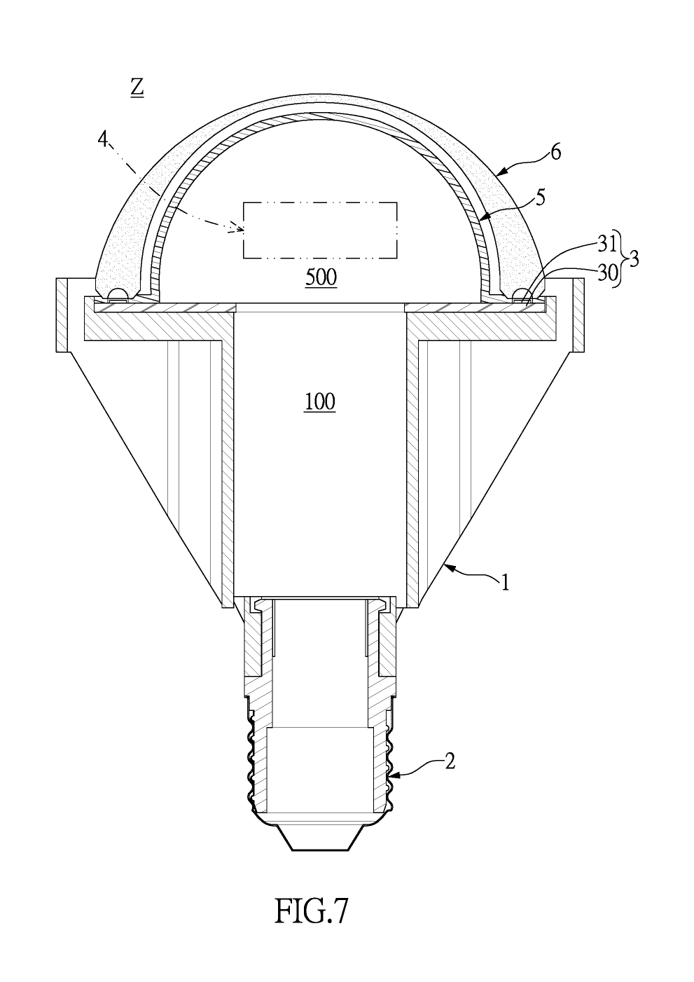

Please note, referring to FIG. 7, FIG. 7 shows a cross-sectional, schematic view of the LED bulb structure according to another one of embodiments of the instant disclosure, another embodiment of the instant disclosure provides another insulation cover 5 without the convex portion 52 and another light-guiding cover 6 without through opening 600.

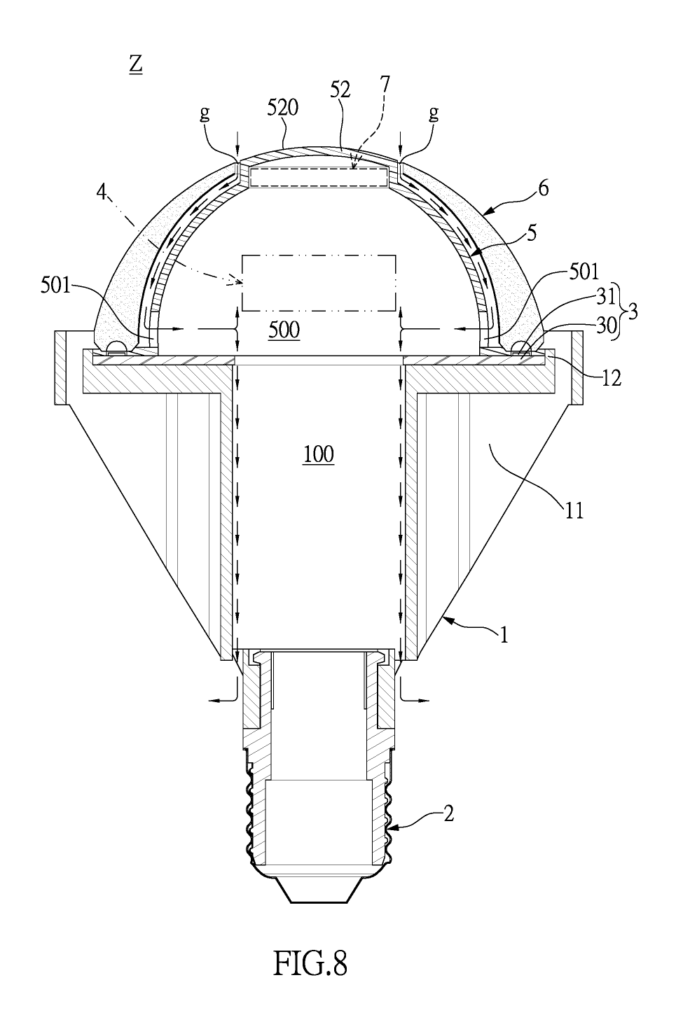

Please note, referring to FIG. 8, FIG. 8 shows a cross-sectional, schematic view of the LED bulb structure according to yet another one of embodiments of the instant disclosure. The convex portion 52 has a receiver receiving space (not labeled) formed therein and communicated with (in air communication with) the first receiving space 500, and a wireless signal receiver 7 (or a wireless signal transmitter) is received inside the receiver receiving space of the convex portion 52 so as to reduce space utilization rate and increase heat-dissipating efficiency of the first receiving space 500. For example, the instant disclosure can use a wireless signal receiver 7 and a wireless signal transmitter both received inside the receiver receiving space of the convex portion 52. In addition, cold air can be guided into the first receiving space 500 and the second receiving space 100 through the surrounding gap g, and then the air can leave the LED bulb structure Z through vent hole (not labeled), so as to increase the heat-dissipating efficiency of the LED bulb structure Z.

In conclusion, the instant disclosure provides an LED bulb structure Z, comprising a heat dissipation base 1, a power connector 2, a light-emitting module 3, a driving circuit 4, an insulation cover 5, and a light-guiding cover 6. The heat dissipation base 1 has a plurality of surrounding heat-dissipating fins 11 surroundingly disposed on an outer perimeter surface thereof. The power connector 2 is disposed on a bottom side of the heat dissipation base 1. The light-emitting module 3 includes a circuit substrate 30 disposed on a top side of the heat dissipation base 1 and a plurality of LED chips 31 electrically connected to the circuit substrate 30, and the LED chips 31 are surroundingly disposed on a top surface 300 of the circuit substrate 30 and adjacent to an outer perimeter surface 301 of the circuit substrate 30. The driving circuit 4 is electrically connected between the power connector 2 and the light-emitting module 3. The insulation cover 5 is disposed on the circuit substrate 30. The light-guiding cover 6 is used to cover the insulation cover 5. The light-guiding cover 6 has a light input curved surface 601, a light-reflecting curved surface 602, and a light output curved surface 603 respectively formed on a bottom side, an inner surface, and an outer surface thereof.

Because the LED chips 31 are surroundingly disposed on the top surface 300 of the circuit substrate 30 and adjacent to the outer perimeter surface 301 of the circuit substrate 30, the heat-dissipating path of the LED chips 31 is reduced and the heat-dissipating efficiency of the LED chips 31 is increased.

The aforementioned descriptions merely represent the preferred embodiments of the instant disclosure, without any intention to limit the scope of the instant disclosure which is fully described only within the following claims. Various equivalent changes, alterations or modifications based on the claims of the instant disclosure are all, consequently, viewed as being embraced by the scope of the instant disclosure.

1. AN LED bulb structure, comprising:
a heat dissipation base having a plurality of surrounding heat-dissipating fins surroundingly disposed on an outer perimeter surface thereof;
a power connector disposed on a bottom side of the heat dissipation base;
a light-emitting module including a circuit substrate disposed on a top side of the heat dissipation base and a plurality of LED chips electrically connected to the circuit substrate, wherein the LED chips are surroundingly disposed on a top surface of the circuit substrate and adjacent to an outer perimeter surface of the circuit substrate;
a driving circuit electrically connected between the power connector and the light-emitting module;
an insulation cover disposed on the circuit substrate, wherein the insulation cover has a surrounding main portion, a convex portion disposed on a top side of the surrounding main portion, and a surrounding extending portion outwardly and surroundingly extended from a bottom side of the surrounding mina body and disposed on the circuit substrate, and the surrounding extending portion has a plurality of through holes for respectively receiving the LED chips; and
a light-guiding cover disposed on the surrounding extending portion of the insulation cover to cover the surrounding main portion of the insulation cover, wherein the light-guiding cover has a through opening formed on a top side thereof for exposing the convex portion, the light-guiding cover has a plurality of light input curved surfaces inwardly concaved therefrom and respectively facing the LED chips, the light-guiding cover has a light-reflecting curved surface and a light output curved surface respectively formed on an inner surface and an outer surface thereof, and a thickness of the light-guiding cover is decreased gradually from bottom to top;
wherein a first receiving space is formed above the circuit substrate and surrounded by the insulation cover, a second receiving space is formed under the circuit substrate and is surrounded by the heat dissipation base.

2. The LED bulb structure of claim 1, wherein the driving circuit is placed inside one of the first receiving space and the second receiving space.

3. The LED bulb structure of claim 1, wherein the heat dissipation base has a plurality of top heat-dissipating fins disposed on the top side thereof for surrounding the light-emitting module, and the top heat-dissipating fins directly contact the circuit substrate of the light-emitting module.

4. The LED bulb structure of claim 1, wherein the light-guiding cover includes a light-guiding body, a plurality of reflective microparticles disposed inside the light-guiding body, and a plurality of carrier substances disposed inside the light-guiding body to carry the reflective microparticles to be uniformly diffused inside the light-guiding body, wherein the refractive of the light-guiding body is different from the index refractive index of the reflective microparticle, the viscosity of the carrier substance is smaller than the viscosity of the light-guiding body, and the flowability of the reflective microparticles inside the light-guiding body is increased through the carrier substances.

5. The LED bulb structure of claim 4, wherein the light-guiding cover includes a plurality of light-guiding microstructures disposed on the light-reflecting curved surface and a light-reflecting layer disposed on the light-reflecting curved surface to cover the light-guiding microstructures, and the index refractive index of the light-guiding microstructure is different from the index refractive index of the light-reflecting layer, wherein the light pattern of an illuminating light source generated by the LED bulb structure is adjusted according to the number of the light-guiding microstructures.

6. The LED bulb structure of claim 1, wherein the convex portion of the insulation cover has a curved surface formed on a top side thereof, the curved surface of the insulation cover and the light output curved surface of the light-guiding cover are formed on a same sphere track, and a surrounding gap is formed between the convex portion of the insulation cover and the light-guiding cover and inside the through opening.

7. The LED bulb structure of claim 1, wherein the convex portion has a receiver receiving space formed therein and communicated with the first receiving space, and a wireless signal receiver or a wireless signal transmitter is received inside the receiver receiving space of the convex portion.

8. AN LED bulb structure, comprising:
a heat dissipation base;
a power connector disposed on a bottom side of the heat dissipation base;
a light-emitting module including a circuit substrate disposed on a top side of the heat dissipation base and a plurality of LED chips electrically connected to the circuit substrate, wherein the LED chips are surroundingly disposed on a top surface of the circuit substrate and adjacent to an outer perimeter surface of the circuit substrate;
an insulation cover disposed on the circuit substrate, wherein the insulation cover has a surrounding main portion, a convex portion disposed on a top side of the surrounding main portion, and a surrounding extending portion outwardly and surroundingly extended from a bottom side of the surrounding mina body and disposed on the circuit substrate; and
a light-guiding cover disposed on the surrounding extending portion of the insulation cover to cover the surrounding main portion of the insulation cover, wherein the light-guiding cover has a through opening formed on a top side thereof for exposing the convex portion, the light-guiding cover has a light input curved surface, a light-reflecting curved surface, and a light output curved surface respectively formed on a bottom side, an inner surface, and an outer surface thereof, and a thickness of the light-guiding cover is decreased gradually from bottom to top.

9. The LED bulb structure of claim 8, wherein the light-guiding cover includes a light-guiding body, a plurality of reflective microparticles disposed inside the light-guiding body, and a plurality of carrier substances disposed inside the light-guiding body to carry the reflective microparticles to be uniformly diffused inside the light-guiding body, wherein the refractive of the light-guiding body is different from the index refractive index of the reflective microparticle, the viscosity of the carrier substance is smaller than the viscosity of the light-guiding body, and the flowability of the reflective microparticles inside the light-guiding body is increased through the carrier substances.

10. The LED bulb structure of claim 9, wherein the light-guiding cover includes a plurality of light-guiding microstructures disposed on the light-reflecting curved surface and a light-reflecting layer disposed on the light-reflecting curved surface to cover the light-guiding microstructures, and the index refractive index of the light-guiding microstructure is different from the index refractive index of the light-reflecting layer, wherein the light pattern of an illuminating light source generated by the LED bulb structure is adjusted according to the number of the light-guiding microstructures.

11. The LED bulb structure of claim 8, wherein the convex portion of the insulation cover has a curved surface formed on a top side thereof, the curved surface of the insulation cover and the light output curved surface of the light-guiding cover are formed on a same sphere track, and a surrounding gap is formed between the convex portion of the insulation cover and the light-guiding cover and inside the through opening.

12. The LED bulb structure of claim 8, wherein the convex portion has a receiver receiving space formed therein and communicated with the first receiving space, and a wireless signal receiver or a wireless signal transmitter is received inside the receiver receiving space of the convex portion.

13. N LED bulb structure, comprising:
a heat dissipation base having a plurality of surrounding heat-dissipating fins surroundingly disposed on an outer perimeter surface thereof;
a power connector disposed on a bottom side of the heat dissipation base;
a light-emitting module including a circuit substrate disposed on a top side of the heat dissipation base and a plurality of LED chips electrically connected to the circuit substrate, wherein the LED chips are surroundingly disposed on a top surface of the circuit substrate and adjacent to an outer perimeter surface of the circuit substrate;
a driving circuit electrically connected between the power connector and the light-emitting module;
an insulation cover disposed on the circuit substrate; and
a light-guiding cover covering the insulation cover, wherein the light-guiding cover has a light input curved surface, a light-reflecting curved surface, and a light output curved surface respectively formed on a bottom side, an inner surface, and an outer surface thereof, and a thickness of the light-guiding cover is decreased gradually from bottom to top;
wherein a first receiving space is formed above the circuit substrate and surrounded by the insulation cover, a second receiving space is formed under the circuit substrate and is surrounded by the heat dissipation base.

14. The LED bulb structure of claim 13, wherein the driving circuit is placed inside one of the first receiving space and the second receiving space.

15. The LED bulb structure of claim 13, wherein the heat dissipation base has a plurality of top heat-dissipating fins disposed on the top side thereof for surrounding the light-emitting module, and the top heat-dissipating fins directly contact the circuit substrate of the light-emitting module.

16. The LED bulb structure of claim 13, wherein the light-guiding cover includes a light-guiding body, a plurality of reflective microparticles disposed inside the light-guiding body, and a plurality of carrier substances disposed inside the light-guiding body to carry the reflective microparticles to be uniformly diffused inside the light-guiding body, wherein the refractive of the light-guiding body is different from the index refractive index of the reflective microparticle, the viscosity of the carrier substance is smaller than the viscosity of the light-guiding body, and the flowability of the reflective microparticles inside the light-guiding body is increased through the carrier substances.

17. The LED bulb structure of claim 16, wherein the light-guiding cover includes a plurality of light-guiding microstructures disposed on the light-reflecting curved surface and a light-reflecting layer disposed on the light-reflecting curved surface to cover the light-guiding microstructures, and the index refractive index of the light-guiding microstructure is different from the index refractive index of the light-reflecting layer, wherein the light pattern of an illuminating light source generated by the LED bulb structure is adjusted according to the number of the light-guiding microstructures.
